(19) United States
(12) Patent Application Publication
(10) Pub. No.: US 2017/0261665 A1
(43) Pub. Date: Sep. 14, 2017

(54) QUANTUM DOT POLARIZATION PLATE

(71) Applicant: Shenzhen China Star Optoelectronics Technology Co. Ltd., Shenzhen City (CN)

(72) Inventor: Bai Bai, Shenzhen City (CN)

(21) Appl. No.: 14/908,127

(22) PCT Filed: Dec. 23, 2015
(86) PCT No.: PCT/CN2015/098505

§ 371 Date: Jan. 28, 2016

(30) Foreign Application Priority Data
Nov. 11, 2015 (CN) 201510765916.0

(51) Int. Cl. G02B 5/30; G02B 1/14; G02F 1/1335; G02B 1/08

(52) U.S. Cl. CPC G02B 5/3016; G02B 1/08; G02B 5/3033; G02B 1/14; G02F 1/133528; G02F 2202/36

(57) ABSTRACT

The present invention provides a quantum dot polarization plate, which includes, arranged in sequence, a release film (16), an adhesive layer (15), a retardation layer (14), a polarization layer (13), a protection layer (12), and a surface protection film (11). The retardation layer (14) is formed a mixed material including quantum dots and disk-like liquid crystal by means of a film formation process and shows dual effects of light emission and viewing angle compensation thereby reducing the operations required for manufacturing the quantum dot polarization plate and allowing the quantum dot polarization plate to maintain light polarity, while effectively increasing color gamut coverage of a display and achieving wide view angle of the display, and the manufacturing operation thereof is simple.

### BACKGROUND OF THE INVENTION

1. Field of the Invention

The present invention relates to the field of display technology, and in particular to a quantum dot polarization plate.

2. The Related Arts

With the progress of technology and science, people get increasingly relying upon communication and transmission of information. Display devices, which serve as a primary carrier and physical basis for exchange and transmission of information, are becoming a hot spot and high land that are pursued by scientists who devote themselves to the study and researches of information photoelectronics.

Quantum dots (QDs) are nanometer semiconductor crystal having a particle size smaller than or close to the Bohr radius, and most of them are three-dimensional nanometer-sized material constituted by elements of II-VI groups or III-V groups. Due to the quantum confinement effect, the transportation of electrons and holes is restricted so that the continuous energy band is converted into discrete energy levels. When the size of quantum dot is different, the quantum confinement of electrons and holes is also different so that the discrete energy level structure is also different. When excited by external energy, quantum dots of different sizes would give of different wavelengths of light, namely different colors of light.

The advantage of the quantum dots is that through adjustment of the size of the quantum dot, it is possible to provide an emission wavelength range that covers infrared band and the entire band of visible light and the emission light has a narrow band and high saturation of color. The quantum dot material has a high quantum conversion efficiency and the property of the material is stable. The manufacturing processes are simple and variable, allowing for production to be made from solutions, making the resources very rich.

However, light, after passing through a quantum dot, is emitted randomly in direction. On the other hand, the operation principle of a liquid crystal display (LCD) device is based on rotation of polarization and birefringence so that through application of an electrical voltage to control the rotation of liquid crystal, linear polarized light passing through an upper polarizer would be rotated to transmit through a lower polarizer (that has a polarization direction perpendicular to the upper polarizer), whereby the upper and lower polarizers and a liquid crystal cell collectively function as an optic switch. It is quite apparent that such an optic switch is generally ineffective to light emitting from a quantum dot. When spread light that passes through a quantum dot travels through liquid crystal, it no longer possible to have the light passing through a pixel well controlled and LCD would suffer leakage of light.

As shown in FIG. 1, a regular polarization plate is made up of multiple layers of films combined together, generally including the following layers, which are, in sequence from top to bottom, a surface protection film 110, a first protection layer 120, a polarization layer 130, a second protection layer 140, an adhesive layer 150, and a peeling protection film 160. To attach, the peeling protection film 160 is peeled off to expose the adhesive layer 150 so that the polarization plate is attached, by the adhesive layer 150, to a substrate to be attached to. After the attachment, the surface protection film 110 is often removed. In the structure of the polarization plate, the core portion is the polarization layer 130, which is generally a polyvinyl alcohol (PVA) layer containing therein iodine molecules that has an effect of light polarization. The first protection layer 120 and the second protection layer 140 are both transparent triacetyl cellulose (TAC) layers primarily for maintaining the polarizer of the polarization layer 130 in a stretched condition, preventing the polarizer from losing moisture, and protecting it from external influence. Contemporarily, a retardation polarization plate that features viewing angle compensation is also available, which, compared to the structure of the regular polarization plate discussed above, additionally comprises a retardation film. Such a retardation film is often a thin film made of disk like liquid crystal molecules.

### SUMMARY OF THE INVENTION

An object of the present invention is to provide a quantum dot polarization plate, which comprises a retardation film, and the retardation film comprises quantum dots and disk-like liquid crystal molecules to function as a light emission layer and also function as a retardation film thereby reducing the operation processes in making a polarization plate, wherein the quantum dot polarization plate of the present invention provides the property of light polarization and also increase cover coverage of a display device and also provides an effect for compensating viewing angle.

To achieve the above object, the present invention provides a quantum dot polarization plate, which comprises, arranged in sequence, a release film, an adhesive layer, a retardation layer, a polarization layer, a protection layer, and a surface protection film;

wherein the retardation layer is formed a mixed material comprising quantum dots and disk-like liquid crystal by means of a film formation process, wherein the quantum dots are in the form of bars.

The quantum dots contained in the retardation layer comprise one of quantum dot of II-VI groups, quantum dots of III-V groups, and carbon quantum dot or a combination of multiple ones thereof.

The quantum dots are subjected to modification through surface grafting or surface coating.

The quantum dots are oil soluble or water soluble.

The quantum dots comprise nanometer particles having a size in the range of 0-20 nm.

The film formation process of the retardation layer comprises one of spray coating, spin coating, printing, and slot die coating.

The quantum dot polarization plate is used as an upper polarizer or a lower polarizer of a liquid crystal display panel.

The polarization layer comprises an iodine-series polarization film or a dye-series polarization film; and the polarization layer is formed of a material comprising polyvinyl alcohol.

The protection layer is formed of a material comprising triacetyl cellulose; and the adhesive layer is formed of a material of pressure-sensitive adhesive.

In use of the quantum dot polarization plate, the release film is peeled off and the quantum dot polarization plate is attached by means of the adhesive layer to substrate to be attached to.

The present invention also provides a quantum dot polarization plate, which comprises, arranged in sequence, a release film, an adhesive layer, a retardation layer, a polarization layer, a protection layer, and a surface protection film;

wherein the retardation layer is formed a mixed material comprising quantum dots and disk-like liquid crystal by means of a film formation process, wherein the quantum dots are in the form of bars;

wherein the quantum dots contained in the retardation layer comprise one of quantum dot of II-VI groups, quantum dots of III-V groups, and carbon quantum dot or a combination of multiple ones thereof;

wherein the quantum dots are subjected to modification through surface grafting or surface coating;

wherein the quantum dots are oil soluble or water soluble; and

wherein the quantum dots comprise nanometer particles having a size in the range of 0-20 nm.

The efficacy of the present invention is that the present invention provides a quantum dot polarization plate, which comprises a retardation layer, and the retardation layer is formed of a mixture of quantum dots and disk-like liquid crystal by means of a film formation process so as to possess dual functions of light emission and viewing angle compensation thereby reducing the operations required for manufacturing the quantum dot polarization plate and allowing the quantum dot polarization plate to maintain light polarity, while effectively increasing color gamut coverage of a display and achieving wide view angle of the display, and the manufacturing operation thereof is simple.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a cross-sectional view showing the structure of a conventional polarization plate;

FIG. 2 is a cross-sectional view illustrating the structure of a quantum dot polarization plate according to the present invention; and

FIG. 3 is a schematic view illustrating the quantum dot polarization plate according to the present invention bonded to a substrate.

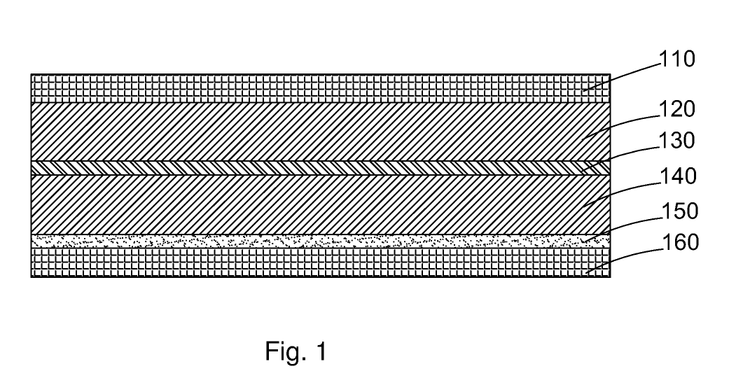

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

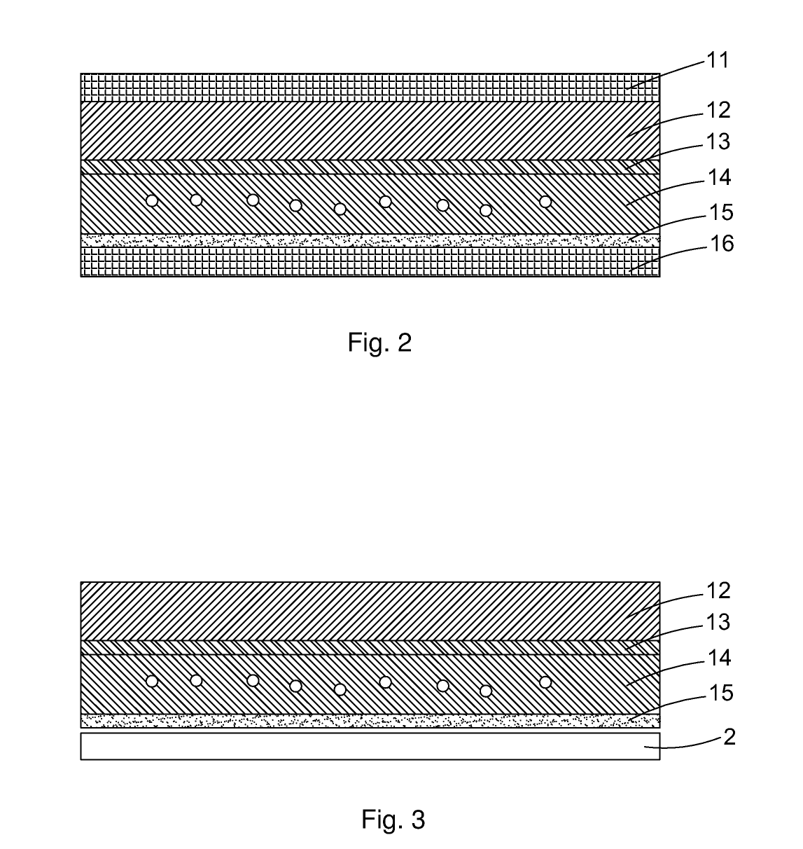

Referring to FIGS. 2-3, the present invention provides a quantum dot polarization plate, which comprises, arranged in sequence from top to bottom, a release film 16, an adhesive layer 15, a retardation layer 14, a polarization layer 13, a protection layer 12, and a surface protection film 11.

The retardation layer 14 is formed a mixed material comprising quantum dots and disk-like liquid crystal by means of a film formation process, wherein the quantum dots are in the form of bars.

Specifically, in the manufacture of the retardation layer 14, the quantum dots, the disk-like liquid crystal, and a treating agent are mixed in a solvent to obtain a mixed material. To achieve a bettered effect of mixture of the quantum dots and the disk-like liquid crystal, addition or reduction of the treating agent or the solvent, or change of the ratios of the components may be taken. And, finally, the film formation process is conducted to form the retardation layer 14.

Specifically, the quantum dots contained in the retardation layer 14 comprise one of quantum dot of II-VI groups (such as CdS, CdSe, CdTe, and ZnSe), quantum dot of III-V groups (such as InP and InAs), and carbon quantum dot or a combination of multiple ones thereof.

Preferably, the quantum dots of the retardation layer 14 are a combination of multiple types of quantum dot to provide a better effect of increasing color gamut and improved mixture.

Specifically, the quantum dots can be quantum dots that are subjected to modification through surface grafting or surface coating so as to have them provide a more uniform and more stable mixing effect in the solvent.

Specifically, the quantum dots are oil soluble or water soluble.

Preferably, the quantum dots are nanometer particles having a particle size between 0-20 nm.

Specifically, the film formation process of the retardation layer 14 includes an operation of spray coating, spin coating, printing, or slot die coating.

Specifically, the polarization plate may serve as an upper polarizer or a lower polarizer of a liquid crystal display panel. Since the quantum dots contained in the retardation layer 14 has the property of light emission, it provides an effect of increasing color gamut coverage. Preferably, the polarization plate is used as the upper polarizer of a liquid crystal display panel. Since the disk-like liquid crystal contained in the retardation layer 14 has an effect of viewing angle compensation, the quantum dot polarization plate, when serving as an upper polarizer of a liquid crystal display panel, may allow for viewing angle compensation for the liquid crystal display panel to thereby provide a wide view angle for a display device.

Further, the retardation layer 14 and the protection layer 12 are respectively arranged at opposite sides of the polarization layer 13 so that the retardation layer 14 and the protection layer 12 collectively provide protection to the polarization layer 13 to prevent the polarization layer 13 from being influenced by the surroundings.

Specifically, the polarization layer 13 comprises an iodine-series polarization film or a dye-series polarization film; and the polarization layer 13 is formed of a material comprising polyvinyl alcohol.

Specifically, the protection layer 12 is formed of a material comprising triacetyl cellulose; the adhesive layer 15 is formed of a material of pressure-sensitive adhesive, preferably polyacrylic acid ester pressure-sensitive adhesive.

Specifically, as shown in FIG. 3, to use the quantum dot polarization plate, the release film 16 is peeled off so that the quantum dot polarization plate can be attached, by means of the adhesive layer 15, to a substrate 2 to be attached to. After the attachment, it often needs to remove the surface protection film 11.

Specifically, the quantum dot polarization plate of the present invention is applicable to a BOA (Black matrix On Array), COA (Color filter On Array), or GOA (Gate Driver on Array) liquid crystal panel.

In summary, the present invention provides a quantum dot polarization plate, which comprises a retardation layer, and the retardation layer is formed of a mixture of quantum dots and disk-like liquid crystal by means of a film formation process so as to possess dual functions of light emission and viewing angle compensation thereby reducing the operations required for manufacturing the quantum dot polarization plate and allowing the quantum dot polarization plate to maintain light polarity, while effectively increasing color gamut coverage of a display and achieving wide view angle of the display, and the manufacturing operation thereof is simple.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A quantum dot polarization plate, comprising, arranged in sequence, a release film, an adhesive layer, a retardation layer, a polarization layer, a protection layer, and a surface protection film;
wherein the retardation layer is formed a mixed material comprising quantum dots and disk-like liquid crystal by means of a film formation process, wherein the quantum dots are in the form of bars.

2. The quantum dot polarization plate as claimed in claim 1, wherein the quantum dots contained in the retardation layer comprise one of quantum dot of II-VI groups, quantum dots of III-V groups, and carbon quantum dot or a combination of multiple ones thereof.

3. The quantum dot polarization plate as claimed in claim 1, wherein the quantum dots are subjected to modification through surface grafting or surface coating.

4. The quantum dot polarization plate as claimed in claim 1, wherein the quantum dots are oil soluble or water soluble.

5. The quantum dot polarization plate as claimed in claim 1, wherein the quantum dots comprise nanometer particles having a size in the range of 0-20 nm.

6. The quantum dot polarization plate as claimed in claim 1, wherein the film formation process of the retardation layer comprises one of spray coating, spin coating, printing, and slot die coating.

7. The quantum dot polarization plate as claimed in claim 1, wherein the quantum dot polarization plate is used as an upper polarizer or a lower polarizer of a liquid crystal display panel.

8. The quantum dot polarization plate as claimed in claim 1, wherein the polarization layer comprises an iodine-series polarization film or a dye-series polarization film; and the polarization layer is formed of a material comprising polyvinyl alcohol.

9. The quantum dot polarization plate as claimed in claim 2, wherein the protection layer is formed of a material comprising triacetyl cellulose; and the adhesive layer is formed of a material of pressure-sensitive adhesive.

10. The quantum dot polarization plate as claimed in claim 1, wherein, in use of the quantum dot polarization plate, the release film is peeled off and the quantum dot polarization plate is attached by means of the adhesive layer to substrate to be attached to.

11. A quantum dot polarization plate, comprising, arranged in sequence, a release film, an adhesive layer, a retardation layer, a polarization layer, a protection layer, and a surface protection film;
wherein the retardation layer is formed a mixed material comprising quantum dots and disk-like liquid crystal by means of a film formation process, wherein the quantum dots are in the form of bars;
wherein the quantum dots contained in the retardation layer comprise one of quantum dot of II-VI groups, quantum dots of III-V groups, and carbon quantum dot or a combination of multiple ones thereof;
wherein the quantum dots are subjected to modification through surface grafting or surface coating;
wherein the quantum dots are oil soluble or water soluble; and
wherein the quantum dots comprise nanometer particles having a size in the range of 0-20 nm.

12. The quantum dot polarization plate as claimed in claim 11, wherein the film formation process of the retardation layer comprises one of spray coating, spin coating, printing, and slot die coating.

13. The quantum dot polarization plate as claimed in claim 11, wherein the quantum dot polarization plate is used as an upper polarizer or a lower polarizer of a liquid crystal display panel.

14. The quantum dot polarization plate as claimed in claim 11, wherein the polarization layer comprises an iodine-series polarization film or a dye-series polarization film; and the polarization layer is formed of a material comprising polyvinyl alcohol.

15. The quantum dot polarization plate as claimed in claim 11, wherein the protection layer is formed of a material comprising triacetyl cellulose; and the adhesive layer is formed of a material of pressure-sensitive adhesive.

16. The quantum dot polarization plate as claimed in claim 11, wherein, in use of the quantum dot polarization plate, the release film is peeled off and the quantum dot polarization plate is attached by means of the adhesive layer to substrate to be attached to.
